(19) United States
(12) Patent Application Publication
(10) Pub. No.: US 2019/0239546 A1
(43) Pub. Date: Aug. 8, 2019

(54) HARD BOUILLON TABLET

(71) Applicant: NESTEC S.A., Vevey (CH)

(72) Inventors: Jimmy Perdana, Singen (DE); Youngbin Kim, Singen (DE); Katharina Bulling, Stuttgart (DE); Michele Marazzato, Konolfingen (CH); Laurent Sagalowicz, Blonay (CH); Christian Kjolby, Bretigny-sur-Morrens (CH)

(21) Appl. No.: 16/343,182

(22) PCT Filed: Oct. 20, 2017
(86) PCT No.: PCT/EP2017/076842

§ 371 Date: Apr. 18, 2019

(30) Foreign Application Priority Data
Oct. 31, 2016 (EP) 16196497.8

(51) Int. Cl. A23L 23/10; A23L 13/50; A23P 10/28

(52) U.S. Cl. CPC A23L 23/10; A23V 2002/00; A23P 10/28; A23L 13/50

(57) ABSTRACT

The invention relates to a hard bouillon tablet and to a process for the production of a hard bouillon tablet wherein a chicken fat having a total saturated fat content of 48 to 72 wt % (based on weight of total fat); and wherein the chicken fat comprises the fatty acids C16:0 in the range of 36 to 55 wt % (based on weight of total fat) and C18:0 in the range of 11 to 19 wt % (based on weight of total fat) is used.

### TECHNICAL FIELD

The invention relates to a hard bouillon tablet and the manufacturing process for the production of a hard bouillon tablet. In particularly the invention relates to a hard bouillon tablet and to a process for the production of a hard bouillon tablet wherein a chicken fat having a total saturated fat content of 48 to 72 wt % (based on weight of total fat) comprising the fatty acids C16:0 in the range of 36 to 55 wt % (based on weight of total fat) and C18:0 in the range of 11 to 19 wt % (based on weight of total fat) is used.

### BACKGROUND

A hard bouillon tablet is an agglomerate of different food ingredients that are initially in a solid physical state at room temperature in a free flowing powder form bound together after pressing in a regular geometrical form being the most common a cubical or rectangular prism also known as bouillon tablet or bouillon cubes. A hard bouillon tablet is widely used as a concentrate to prepare a bouillon, a broth or a soup. The hard bouillon tablet is normally added to a hot aqueous solution, allowing it to dissolve. In addition, a hard bouillon tablet may be used when preparing other dishes, as a seasoning product. The dissolution time of hard bouillon tablets highly depends on it's degree of compaction which can be measured/expressed by the hardness of such a product. The reason to compact powders in a regular form presents several advantages for the commercialisation (e.g. reduction of volume, optimisation of packaging material usage, shelf life and convenience). A habit developed by users of hard bouillon is the crumbing of the tablet into the dish during preparation process either to ensure good distribution and or to accelerate its dissolution time in the cooking water. This crumbliness it's one of the attributes that needs to be ensured during shelf life and therefore a post-hardening of the tablet or cube has to be avoided. A minimum hardness is necessary to allow a wrapping of the tablet. A maximum hardness ensures that a normal user can break the tablet with fingers without the use of additional tools or appliances. When the used fat has less cohesion properties the final product might result in a breakable tablet not suitable for a wrapping/packaging process. A binding system needs therefore to be designed in function of the final hardness the producer wants to achieve to ensure consumer habits as crumbliness and to ensure a minimum mechanical stress resistance through the wrapping/packaging process. A hard bouillon tablet needs to be stable and avoid physical changes during shelf life, e.g. post hardening, either induced by the temperature and/or relative humidity conditions or even by the handling of the product.

A typical hard bouillon tablet comprises salts, taste enhancing compounds like monosodium glutamate (MSG), sugars, starch or flour, fat, flavouring components, vegetables, meat extracts, spices, colorants etc. The amounts of the respective compounds may vary depending on the specific purpose of the product, the market or taste of the consumer that is aimed at.

A conventional way of manufacturing hard bouillon tablets comprises mixing powdered bouillon components with fat and optionally with controlled amounts of oil, and pressing the mix into tablet form.

As the fat used in a hard bouillon tablet should not stain the packaging and/or melt upon storage, hydrogenated vegetable oils/fats are used optionally together with liquid oil.

The most common used fat is palm fat as it provides good technical properties for processing a hard bouillon tablet due to the good flow-ability of the bouillon mass before pressing. In addition palm fat delivers good binding properties to the hard bouillon itself resulting in a good hardness of the tablet but still easy to crumble.

Consumers are increasingly becoming sensitive to palm fat concerns. Many of them perceive palm fat as not healthy and many others perceive it as not environmentally sustainable as a lot of news mention that the rain forest is destroyed to grow palm trees. In addition palm fat has a neutral taste which is on one side an advantage but on the other side flavour compounds/flavour extracts have to be added to a recipe to achieve a certain taste for example chicken flavour has to be added to a chicken bouillon.

EP1401295 describes a hard bouillon tablet which only or mainly contains liquid oil, especially an oil rich in monounsaturated fatty acids and/or polyunsaturated fatty acids, and no or only little amounts of fat. The drawback of using liquid oil instead of fat is that the hard bouillon tablets has post-hardening effect during shelf-life and will therefore loose its crumbliness.

Hence there is an existing need in the art and food industry to provide a better solution for a hard bouillon tablet using no palm fat or at least provides an alternative solution.

### SUMMARY OF THE INVENTION

The object of the present invention is to improve the state of the art or at least provide an alternative for a hard bouillon tablet:
i) avoid using palm fat;
ii) the hard bouillon tablet has a hardness of at least 90N;
iii) avoid the usage of hydrogenated oils and fats;
iv) provide a binder which also add taste to the product;
v) reach a shelf life over 12 month with the same sensory properties;
vi) avoid post-hardening of the tablet;
vii) no migration of liquid ingredients out of the hard bouillon tablet;
viii) to use a fat which is stable against rancidity;
ix) enables the user to break the tablet in crumbles;
x) use a fat which enables the reduction of total amount of fat and/or the amount of added flavour within a recipe

The object of the present invention is achieved by the subject matter of the independent claims. The dependent claims further develop the idea of the present invention.

Accordingly, the present invention provides in a first aspect a hard bouillon tablet comprising
i) 40 to 80% crystalline ingredients (by weight of the composition);
ii) 0.5 to 20% flavourings (by weight of the composition);
iii) 0.5 to 35% amorphous ingredients (by weight of the composition);
iv) 5 to 20% chicken fat (by weight of the composition);
wherein the chicken fat has a total saturated fat content of 48 to 72 wt % (based on weight of total fat); and wherein the chicken fat comprises the fatty acids C16:0 in the range of 36 to 55 wt % (based on weight of total fat) and C18:0 in the range of 11 to 19 wt % (based on weight of total fat).

In a second aspect of the invention, there is provided a process for the preparation of a hard bouillon tablet comprising
a) Mixing 40 to 80% crystalline ingredients, 0.5 to 35% amorphous ingredients, 0.5 to 20% flavourings and 5 to 20% of chicken fat (by weight of the composition);
b) Optionally storage of the mixture;
c) Pressing a hard bouillon tablet;
d) Packaging the hard bouillon tablet;
wherein the chicken fat has a total saturated fat content of 48 to 72 wt % (based on weight of total fat); and
wherein the chicken fat comprises the fatty acids C16:0 in the range of 36 to 55 wt % (based on weight of total fat) and C18:0 in the range of 11 to 19 wt % (based on weight of total fat).

A third aspect of the invention relates to a use of a hard bouillon tablet for preparing a food product.

It has been surprisingly found by the inventors that by using a fractionated chicken fat having a total saturated fat content of 48 to 72 wt % (based on weight of total fat); and wherein the chicken fat comprises the fatty acids C16:0 in the range of 36 to 55 wt % (based on weight of total fat) and C18:0 in the range of 11 to 19 wt % (based on weight of total fat) helps to achieve the necessary attributes to bind different ingredients and fulfils the process and consumer expectations:
the hard bouillon tablet has a good hardness for wrapping;
the tablet breakage during the wrapping process is below 10%
the tablet is easily crumbled as for consumer preference;
the tablet is shelf stable over 12 month without the known drawback as oil/fat migration or water absorption and avoids post-hardening;
the usage of palm fat can be avoided/replaced;
the fat also add taste to the product;
the amount of flavors can be reduced in a recipe.

### DETAILED DESCRIPTION

The present invention pertains to a hard bouillon tablet comprising
i) 40 to 80% crystalline ingredients (by weight of the composition);
ii) 0.5 to 20% flavourings (by weight of the composition);
iii) 0.5 to 35% amorphous ingredients (by weight of the composition);
iv) 5 to 20% chicken fat (by weight of the composition);
wherein the chicken fat has a total saturated fat content of 48 to 72 wt % (based on weight of total fat); and
wherein the chicken fat comprises the fatty acids C16:0 in the range of 36 to 55 wt % (based on weight of total fat) and C18:0 in the range of 11 to 19 wt % (based on weight of total fat).

In a preferred embodiment the present invention pertains to a hard bouillon tablet comprising
i) 40 to 80% crystalline ingredients (by weight of the composition);
ii) 0.5 to 20% flavourings (by weight of the composition);
iii) 0.5 to 35% amorphous ingredients (by weight of the composition);
iv) 5 to 20% chicken fat (by weight of the composition);
wherein the chicken fat has a total saturated fat content of 55 to 65 wt % (based on weight of total fat); and
wherein the chicken fat comprises the fatty acids C16:0 in the range of 41 to 49 wt % (based on weight of total fat) and C18:0 in the range of 13 to 17 wt % (based on weight of total fat).

“Hard bouillon tablet” means “tablet or cube obtained by pressing a free flowing bouillon powder into a tablet or cube form”

“Chicken fat” according to this invention having a total saturated fat content of 48 to 72 wt % (based on weight of total fat) and comprises the fatty acids C16:0 in the range of 36 to 55 wt % (based on weight of total fat) and C18:0 in the range of 11 to 19 wt % (based on weight of total fat) is a fractionated chicken fat, preferably a double fractionated chicken fat. In a preferred embodiment, the hard bouillon tablet of the present invention does not include hydrogenated fat. In a further embodiment, the hard bouillon tablet comprises fat in an amount in the range of 5 to 20% (by weight of the total composition), preferably between 6 to 20%, preferably between 6 to 15%, preferably between 6.5 to 15%, preferably between 6.5 to 14% (by weight of the total composition). In an embodiment the fat has a total saturated fat content of 48 to 72 wt % (based on weight of total fat), preferably 53.5 to 70 wt % (based on weight of total fat), preferably 54.5 to 68 wt % (based on weight of total fat), more preferably 55 to 65 wt % (based on weight of total fat). In an embodiment C18:0 is Stearic acid. In a further embodiment C18:0 is in the range of 11 to 19 wt % (based on weight of total fat), preferably C18:0 is in the range of 12.8 to 19 wt % (based on weight of total fat), preferably C18:0 is in the range of 13 to 18 wt % (based on weight of total fat), preferably C18:0 is in the range of 13 to 17 wt % (based on weight of total fat), more preferably C18:0 is in the range of 13.2 to 16.5 wt % (based on weight of total fat). In an embodiment the fat has a solid fat content at 23° C. of 50 to 80 wt % (based on weight of total fat), preferably 56 to 78 wt % (based on weight of total fat), preferably 57 to 77 wt % (based on weight of total fat), more preferably 58 to 75 wt % (based on weight of total fat). In an embodiment the fat further comprises C16:0. C16:0 is Palmitic acid. In a further embodiment the fat further comprises C16:0 in the range of 36 to 55 wt % (based on weight of total fat), preferably C16:0 is in the range of 40 to 55 wt % (based on weight of total fat), preferably C16:0 is in the range of 39.5 to 55 wt % (based on weight of total fat), preferably C16:0 is in the range of 40 to 51 wt % (based on weight of total fat), preferably C16:0 is in the range of 40.5 to 50 wt % (based on weight of total fat), more preferably C16:0 is in the range of 41 to 49 wt % (based on weight of total fat). In an embodiment the fat has a slip melting point of 46 to 58° C., preferably a slip melting point of 48 to 58° C., preferably a slip melting point of 50 to 58° C., preferably a slip melting point of 52 to 58° C., preferably a slip melting point of 52.5 to 58° C., more preferably a slip melting point of 52.5 to 56° C. In an embodiment the fat is a 100% non-hydrogenated fat. In an embodiment the fat does not include palm fat.

Standard commercial available chicken fat (see example 1) has a total saturated fat content of 25 to 29 wt % (based on weight of total fat) comprising the fatty acids C16:0 in the range of 18 to 23 wt % (based on weight of total fat) and C18:0 in the range of 3 to 7 wt % (based on weight of total fat). Chicken fat in its original form is semi-liquid at ambient condition at 20° C.

“Slip Melting point” is defined according to AOCS Official Method Cc 3-25 as the temperature at which fat softens and becomes sufficiently fluid to slip in an open capillary tube.

“Crystalline ingredients” according to this invention means at least one ingredient of salt, monosodium glutamate or sugar. The hard bouillon tablet comprises 40 to 80% (by weight of the composition) crystalline ingredients of at least one of salt, monosodium glutamate, sugar or citric acid anhydrous, preferably 45 to 75%, preferably 45 to 70%, preferably 45 to 65%, preferably 50 to 65%, more preferably 52 to 63% (by weight of the composition) crystalline ingredients of at least one of salt, monosodium glutamate or sugar. Salt is preferably sodium chloride, but can also comprise other edible salts capable of imparting or enhancing a salty taste perception, such as potassium chloride. In a further embodiment, the composition comprises salt in an amount in the range of 20 to 58% (by weight of the composition), preferably between 30 to 55%, preferably between 35 to 50% (by weight of the composition). In a further embodiment, the composition comprises monosodium glutamate in an amount in the range of 0 to 25% (by weight of the composition), preferably between 0 to 20%, preferably between 0 to 15%, preferably between 0.5 to 25%, preferably between 0.5 to 15%, preferably between 5 to 10% (by weight of the composition). In a further embodiment, the composition comprises sugar in an amount in the range of 0 to 20% (by weight of the composition), preferably between 0 to 15%, preferably between 0.5 to 15%, preferably between 5 to 10% (by weight of the composition). In a further embodiment, the composition comprises citric acid anhydrous in an amount in the range of 0 to 5% (by weight of the composition), preferably between 0.5 to 4%, preferably between 0.5 to 1.5% (by weight of the composition).

“Amorphous ingredients” according to this invention means at least one ingredient of yeast extract, maltodextrin, starches, flours, vegetable extract, glucose syrup, or onion powder. The hard bouillon tablet comprises 0.5 to 35% amorphous ingredients (by weight of the composition) composed of at least one of yeast extract, maltodextrin, starches, flours vegetable extract or glycose syrup, preferably 2 to 35%, preferably 5 to 35%, preferably 5 to 30%, preferably 5 to 25%, preferably 5 to 20%, preferably 5 to 15%, preferably 7 to 12% (by weight of the composition). In a further embodiment, the composition comprises yeast extract in an amount in the range of 0 to 15% (by weight of the composition), preferably between 1 to 15%, preferably between 5 to 10% (by weight of the composition). In a further embodiment, the composition comprises starches and/or flours in an amount in the range of 0 to 15% (by weight of the composition), preferably between 1 to 15%, preferably between 5 to 10% (by weight of the composition). In a further embodiment, the composition comprises glucose syrup in an amount in the range of 0 to 15% (by weight of the composition), preferably between 1 to 15%, preferably between 5 to 10% (by weight of the composition). In a further embodiment, the composition comprises maltodextrin in an amount in the range of 0 to 15% (by weight of the composition), preferably between 1 to 15%, preferably between 5 to 10% (by weight of the composition).

The term “flavourings” in the context of the composition means flavouring agents, herbs, spices, vegetables, meat and fish components (in wet or powder form). Flavouring agents can include parsley, celery, fenugreek, lovage, rosemary, marjoram, dill, tarragon, coriander, ginger, lemongrass, curcuma, chili, ginger, paprika, mustard, garlic, onion, turmeric, tomato, coconut milk, cheese, oregano, thyme, basil, chillies, paprika, tomato, pimento, jalapeno pepper, white pepper powder and black pepper. In a further embodiment, the composition comprises flavourings in an amount in the range of 0.5 to 20% (by weight of the composition), preferably between 1 to 20%, preferably between 5 to 20% (by weight of the composition).

In a further embodiment, the composition comprises oil in an amount in the range of 0 to 5% (by weight of the composition), preferably between 0.5 to 5% (by weight of the composition), preferably between 0.5 to 3% (by weight of the composition). In a preferred embodiment, the oil is a vegetable oil. Preferably, the oil is selected from the group consisting of sunflower oil, rape seed oil, cotton seed oil, peanut oil, soya oil, olive oil, coconut oil, or a combination thereof; more preferably sunflower oil.

Oil of the present seasoning product is liquid at a room temperature of 25° C., preferably at a room temperature of 20° C. Fat of the present invention is solid at a room temperature of 25° C., preferably at a room temperature of 20° C.

The term “flow-ability” is the flow properties on how easily a powder flows. Flow-ability index (FFC) is quantified as the ratio of consolidation stress a to unconfined yield strength a according to “Schulze, D. (2006). Flow properties of powders and bulk solids. Braunschweig/Wolfenbuttel, Germany: University of Applied Sciences.” In an embodiment flow-ability index (FFC) of the bouillon powder measured at 23° C. is at least 3.2, preferably between the range of 3.4 to 12, preferably between the range of 3.5 to 10, preferably between the range of 3.5 to 8.0 at 23° C.

In an embodiment, the hard bouillon tablet has a tablet hardness of at least 90 N, preferably at least 100N, preferably at least 110N, preferably at least 120N, preferably between 90 to 500N, preferably between 90 to 300N, preferably between 90 to 250N, preferably between 100 to 500N, preferably between 100 to 300N, preferably between 100 to 250N.

In an embodiment the hard bouillon tablet is shelf-stable over 12 months and therefore has a water activity of below 0.5, preferably between 0.1 to 0.5.

### EXAMPLES

The invention is further described with reference to the following examples. It is to be appreciated that the examples do not in any way limit the invention.

### Preparation of Fractionated Chicken Fat

An amount of 10 kg chicken fat was heated at 70° C. and kept at 1 hour to ensure it was completely melted (clear liquid was observed). The molten fat is subjected to crystallization in a pilot scale crystalliser (L-Frac from DeSmet Ballestra, Belgium) by controlled cooling steps from 70° C. to reach a temperature between 8 and 15° C. under gentle stirring (15-30 rpm) for 2 to 30 h, preferably for 5 to 20 h. Temperature profile of cooling steps are appropriately set in such a manner that a product to be obtained after the crystallization will be large suspended stearin particles in a olein slurry that can be transported by a pump or pressured air. Cooling was performed using a ramp profile with isothermal steps in between. Subsequently, the slurry was transferred to a membrane filter press and filtered and pressed with pressures up to 35 bar, preferably up to 30, more preferably up to 20 bar, for 1 to 6 h, preferably for 2 to 4 h. This process step delivers a fat as in comparison example 2.

After filtration and pressing, the recovered solid cake (stearin) was heated again at 80° C. and kept at 1 hour to ensure it was completely melted (clear liquid was observed). The molten fat is subjected to crystallization in a pilot scale crystalliser (L-Frac from DeSmet Ballestra, Belgium) by cooling from 80° C. to a temperature between 40 and 55° C., preferably between 45 and 50° C., under gentle stirring (15-30 rpm) for 2 to 30 h, preferably for 5 to 20 h. Temperature profile of cooling steps are appropriately set in such a manner that a product to be obtained after the crystallization will be large suspended stearin particles in a olein slurry that can be transported by a pump or pressured air. Cooling was performed using a ramp profile with isothermal steps in between. Subsequently, the slurry was transferred to a membrane filter press and filtered and pressed with pressures between up to 35 bar, preferably up to 30 bar, more preferably up to 20 bar for 1 to 6 h, preferably for 2 to 4 h. A fat is obtained as described within example 3-5, preferably example 5. Examples 3-4 can be also prepared by mixing a fat of example 5 with a fat of comparison example 2 (fat blend).

### Preparation of Bouillon Powder

Melted fat or powdered fat can alternatively be used in bouillon powder preparation. When fat is introduced in melted form, all ingredients except fat were weighted in PG5002S balance (Mettler-Toledo, USA) and then mixed manually. Afterwards, fat that has been completely melted at 80° C. (clear and transparent in appearance) was added to powdered mixture. When fat is introduced in powdered form, all ingredients except fat were weighted in PG5002S balance and then mixed manually. After fat is introduced, the mixture was transferred to Thermomix Type 31-1 (Vorwerk Elektrowerke GmbH & Co. AG, Germany). Mixing using Thermomix was carried out in speed 3 for 30 s with propeller rotation was set to reverse direction. Nevertheless it is also possible to have a different order of mixing, for example to mix the crystalline ingredients with fat and then add further the other ingredients and mix further. One batch mixing was carried out for 500 g bouillon powder. The resulting powder was then stored in a sealed box for 24 h at room temperature prior to pressing.

### Flow-Ability Analysis

Flow-ability was measured using a Schulze Ring Shear Tester RST-01.pc according to ASTM D6467. Flow-ability was presented as Flowability Index (FFC). Pre-shear normal stress was set to 2600 Pa and shear normal stress to 390, 1235, and 2080 Pa.

### Pressing of Bouillon Tablet

Pressing of bouillon tablet was carried out with Flexitab Tablet Pressing equipment (Roltgen GmbH, Germany). Ten gram of bouillon powder was automatically fed to tableting mold (31 mm in length and 23 mm in width) and pressed with force of 13 kN.

### Hardness Measurement of Bouillon Tablet

Hardness measurement was carried out using Texture Analyser TA-HDplus (Stable Micro System, UK) equipped with 250 kg load cell and P/75 compression platen. Texture Analyser test mode was set to “Compression” with pre-test speed of 1 mm/s, test speed of 0.5 mm/s, post-test speed of 10 mm/s, target mode of “Distance”, distance of 3 mm, halt time was set to “No”, way back of 10 mm, trigger type to “Auto(Force), and trigger force of 50 gram. Bouillon tablet was placed centrally in vertical-landscape orientation. Hardness measurement was carried out in 10 replication.

### Induction Period of Fat:

The induction period is defined as the period (measured in hours) during which no oxidative, volatile components are generated under certain defined conditions. The induction period is determined based on ISO method 6886:2006; Rancimat/Oxidative Stability Instrument; at 110.0±0.1° C. (230±0.2° F.); 3.0±0.01 g oil, airflow: 10.0 I/h.

### Examples 1-5

Different kind of fats have been tested.

| Recipe | Comp Ex. 1 | Comp. Ex. 2 | Ex. 3 | Ex. 4 | Ex. 5 |
|---|---|---|---|---|---|
| Salt | 49 wt % | 49 wt % | 49 wt % | 49 wt % | 49 wt % |
| MSG | 20 wt % | 20 wt % | 20 wt % | 20 wt % | 20 wt % |
| Maltodextrin | 10 wt % | 10 wt % | 10 wt % | 10 wt % | 10 wt % |
| Starch | 10 wt % | 10 wt % | 10 wt % | 10 wt % | 10 wt % |
| Flavourings | 1 wt % | 1 wt % | 1 wt % | 1 wt % | 1 wt % |
| Fat | 10 wt % | 10 wt % | 10 wt % | 10 wt % | 10 wt % |
| | chicken fat | chicken fat | chicken fat | chicken fat | chicken fat |

Fat Composition

| | | | | | |
|---|---|---|---|---|---|
| C16:0 | 21.2 | 32.7 | 39.3 | 42.2 | 45.1 |
| C18:0 | 5.01 | 9.3 | 12.2 | 13.5 | 14.9 |
| SFA (g/100 g) | 27 | 43.3 | 52.9 | 57.2 | 61.6 |
| SFC at 23° C. (%) | 3.5 | 45.7 | 54.7 | 62.2 | 71.6 |
| SFC at 30° C. (%) | 1.3 | 27.2 | 43.8 | 51.3 | 59.6 |
| Induction period | 12.12 | 26.1 | 34.1 | 35.8 | 40.5 |
| (h) at 110° C. | | | | | |
| Fat slip melting | <25 | 42.8 | 51.4 | 53.2 | 53.9 |
| point (° C.) | | | | | |

Flowability index (FFC) and appearance of bouillon powder with powdered fat

| | | | | | |
|---|---|---|---|---|---|
| FFC at 23° C. | 1.4 | 1.9 | 3.6 | 4.2 | 5.0 |
| Appearance | Lumps | Lumps | No lumps | No lumps | No lumps |
| Tablet hardness | 27.6 | 40.8 | 94.8 | 123.2 | 193.1 |
| (N) | | | | | |
| Tablet Breakage | n.a | 99% | 9% | 5% | 3.5% |

Example 1 to 5 shows that the induction period, slip melting point and flow-ability of bouillon powder improves when fat with higher SFA content has been used. The induction period of the fat, slip melting point of the fat and the flow-ability of bouillon powder is much improved when a fat is introduced having a saturated fat content higher than 48 wt %. Additionally, these recipes shows no lumps formation for a bouillon powder, ensuring good dosing and therefore accuracy of tableting. The comparison examples 1 to 2 have a lower tablet hardness as the chicken fat of the invention having a total saturated fat content of 48 to 72 wt % (based on weight of total fat) and the fatty acids C16:0 in the range of 41 to 49 wt % (based on weight of total fat) and C18:0 in the range of 13 to 17 wt % (based on weight of total fat), which results in a tablet breakage of less than 9% during a wrapping process of the tablet. The wrapping of the tablet has been performed with a Theegarten wrapping machine.

A technical panel of 6 trained people evaluated the crumbliness of example 2-5. The tablet of example 2 has been perceived as too soft and all participants complained about oily/sticky fingers. Example 3-5 have good crumbliness properties and no complaints of the participants regarding oily fingers has been described.

### Example 6: Measurement of Oiling Out from Bouillon Tablet

Oiling out was quantified by placing bouillon tablets horizontally on a Schleicher & Schuell 90 mm filter paper circle (Whatman, UK). Subsequently the samples were stored for 4 days in a Climate Chamber ICH110 (Memmert GmbH+Co. KG, Germay) set to relative humidity (RH) of 30%, fan speed of 40%, and temperatures of 23, 30, and 37° C.

After storage, image of the filter paper was acquired using DigiEye apparatus (Verifide, UK) equipped with Nikon D90 and Nikon 35 mm f/2 lens. DigiEye lighting was set to “diffuse” and lens aperture was set to f/8. Severity of oil staining (A_{staining}) was quantified as the area in filter paper covered with oil compared to the contact area between filter paper and bouillon tablet:

$${A}_{staining} = \frac{{A}_{filter}}{{A}_{tablet}} \times \% OS$$

with A_{filter} the area of the filter paper (6.36·10⁻³ m²), A_{tablet} the contact area between filter paper and bouillon tablet (7.13·10⁻⁴ m²), and % OS the percent area of the filter paper covered with the oil stain determined using “Unisort” feature in DigiEye software.

### A_{staining} at Varying Storage Temperature in %

| | Oil staining (%) | | |
|---|---|---|---|
| Sample | 25° C. | 30° C. | 37° C. |
| Example 1 | 154.7 | 195.2 | 406.6 |
| Example 2 | 28.8 | 81.2 | 146.9 |
| Example 3 | 1.6 | 4.9 | 51.6 |
| Example 4 | 1.4 | 5.6 | 11.6 |
| Example 5 | 0.9 | 2.2 | 4.4 |

Example 1 using standard chicken fat shows severe oiling out. Single fractionation of chicken fat reduces the tendency of oil staining as shown for example 2. Nevertheless the oil staining is still not acceptable and is further improved with the fat of the invention as shown examples 3-5. During a shelf-life of 12 months there was no oil staining observed on the surface of the packaging material for examples 3 to 5.

### Example 7: Dissolution Time in Hot Water

One piece of hard bouillon tablet (10 g) is dissolved in 500 ml water at a temperature of 85° C. and continuously stirred at 600 rpm with 60 mm magnetic stirrer. Measurement is carried out in 6 replication.

| | Average dissolution time (s) |
|---|---|
| Example 1 | 25.3 |
| Example 2 | 30.7 |
| Example 3 | 31.0 |
| Example 4 | 31.5 |
| Example 5 | 31.5 |

The dissolution times are comparable. Only example 1 having the lowest tablet hardness is faster. Nevertheless an increase of SFA and hardness of the tablet does not increase the dissolution time as shown for example 2 to 5.

### Example 8-11: Different Amounts of Ingredients Used

| Recipe | Ex. 8 | Ex. 9 | Ex. 10 | Ex. 11 |
|---|---|---|---|---|
| Salt | 51.7 wt % | 48.3 wt % | 51.7 wt % | 54.0 wt % |
| MSG | 21.7 wt % | 19.3 wt % | 12.4 wt % | — |
| Sugar | — | — | — | 8.2 wt % |
| Maltodextrin | 9.3 wt % | 8.7 wt % | 10.3 wt % | — |
| Starch | 10.3 wt % | 9.7 wt % | 10.3 wt % | 9.0 wt % |
| Flavourings | 1.0 wt % | 1.0 wt % | 8.3 wt % | 11.8 wt % |
| Vegetable extract | — | — | — | 7.0 wt % |
| Chicken fat | 7.0 wt % | 13.0 wt % | 7.0 wt % | 10.0 wt % |

Chicken fat composition

| | | | | |
|---|---|---|---|---|
| C16:0 | 45.1 | 45.1 | 45.1 | 45.1 |
| C18:0 | 14.9 | 14.9 | 14.9 | 14.9 |
| SFA (g/100 g) | 61.6 | 61.6 | 61.6 | 61.6 |
| SFC at 23° C. (%) | 71.6 | 71.6 | 71.6 | 71.6 |
| SFC at 30° C. (%) | 59.6 | 59.6 | 59.6 | 59.6 |
| Tablet hardness (N) | 134 | 150 | 114 | 115 |

### Example 12-13: Comparison Bouillon of Taste

| Recipe | Ex. 12 | Ex. 13 |
|---|---|---|
| Salt | 48.6 wt % | 48.6 wt % |
| Sugar | 12.5 wt % | 12.5 wt % |
| Starch | 11.2 wt % | 23.6 wt % |
| Yeast extract and | 5.3 wt % | 5.3 wt % |
| vegetable extracts, | | |
| Flavorings including | 9.4 wt % | — |
| chicken flavor | | |
| Palm fat | 10.0 wt % | — |
| Chicken fat as within | 3.0 wt % | |
| example 1 | | |
| Chicken fat as within | — | 10.0 wt % |
| example 5 | | |
| Tablet hardness (N) | 114 | 119 |

6 internal experienced panelists were used to rate the taste of a bouillon prepared from example 12 and 13. A hard bouillon tablet of 10 gr has been diluted in 500 ml hot water (80° C.). All 6 panellists rated example 13 as being meatier and having a stronger chicken taste compared to example 12. As shown above example 13 has a less total amount of fat (10% in example 13 vs 13% in example 12) and no chicken flavor at all within the recipe.

1. A hard bouillon tablet comprising:
40 to 80% crystalline ingredients (by weight of the composition);
0.5 to 20% flavourings (by weight of the composition);
0.5 to 35% amorphous ingredients (by weight of the composition);
5 to 20% chicken fat (by weight of the composition);
wherein the chicken fat has a total saturated fat content of 48 to 72 wt % (based on weight of total fat); and
wherein the chicken fat comprises the fatty acids C16:0 in the range of 36 to 55 wt % (based on weight of total fat) and C18:0 in the range of 11 to 19 wt % (based on weight of total fat).

2. A hard bouillon tablet as claimed in claim 1, wherein the chicken fat is a non-hydrogenated chicken fat.

3. A hard bouillon tablet as claimed in claim 1, wherein the chicken fat is a non-hydrogenated fractionated chicken fat.

4. A hard bouillon tablet as claimed in claim 1, wherein the chicken fat has a slip melting point of 46 to 58° C.

5. A hard bouillon tablet as claimed in claim 1, wherein the crystalline ingredient is selected from the group consisting of salt, monosodium glutamate, sugar or citric acid anhydrous and combinations thereof.

6. A hard bouillon tablet as claimed in claim 1, wherein the amorphous ingredients is selected from the group consisting of yeast extract, maltodextrin, starches, flours, vegetable extract, glycose syrup or onion powder and combinations thereof.

7. A hard bouillon tablet as claimed in claim 1, wherein the amount of amorphous ingredients is in the range of 5 to 30% (by weight of the composition).

8. A hard bouillon tablet as claimed in claim 1, wherein the chicken fat has a solid fat content in the range of 55 to 80 wt % (by weight of the composition) at 23° C.

9. A hard bouillon tablet as claimed in claim 1 does not include palm fat.

10. A hard bouillon tablet as claimed in claim 1 further comprises 0 to 5% oil (by weight of the composition).

11. A hard bouillon tablet as claimed in claim 1, wherein the hard bouillon tablet has a tablet hardness of at least 90 N.

12. A process for the preparation of a hard bouillon tablet comprising 40 to 80% crystalline ingredients (by weight of the composition); 0.5 to 20% flavourings (by weight of the composition); 0.5 to 35% amorphous ingredients (by weight of the composition); 5 to 20% chicken fat (by weight of the composition); wherein the chicken fat has a total saturated fat content of 48 to 72 wt % (based on weight of total fat); and wherein the chicken fat comprises the fatty acids C16:0 in the range of 36 to 55 wt % (based on weight of total fat) and C18:0 in the range of 11 to 19 wt % (based on weight of total fat) comprising:
mixing all ingredients;
pressing a hard bouillon tablet; and
packaging the hard bouillon tablet.

13. (canceled)
